(19) United States
(12) Patent Application Publication
(10) Pub. No.: US 2026/0286998 A1
(43) Pub. Date: Sep. 24, 2026

(54) FASTENING DEVICE FOR PANELS, IN PARTICULAR FOR GLASS PLATES

(71) Applicant: MYPRO RESEARCH S.R.L., Thiene (VI) (IT)

(72) Inventor: Giancarlo BRUN, Thiene (VI) (IT)

(73) Assignee: MYPRO RESEARCH S.R.L., Thiene (VI) (IT)

(21) Appl. No.: 19/474,533

(22) PCT Filed: Mar. 25, 2024
(86) PCT No.: PCT/IB2024/052832

§ 371 Date: Oct. 10, 2025

(30) Foreign Application Priority Data
Apr. 14, 2023 (IT) 102023000007215

(51) Int. Cl. F16B 5/06; F16B 2/14

(52) U.S. Cl. CPC F16B 5/0685; F16B 2/14; F16B 5/0635

(57) ABSTRACT

The present invention relates to a fastening device (10; 210; 310; 410; 510; 610; 710) for a panel (4), in particular for a glass plate (4), said device (10; 210; 310; 410; 510; 610; 710) comprising a first element (20; 20′) having a base portion (22; 22′), a first lateral portion (24; 24′) extending from the base portion (22; 22′) and a second lateral portion (26; 26′) extending from the base portion (22; 22′) adapted to define an intermediate zone (28) for receiving the panel (4). The first lateral portion (24; 24′) is adapted to be arranged facing a first external face (5a) of the panel (4) and the second lateral portion (26; 26′) is adapted to be arranged facing a second external face (5b) of the panel (4). The device comprises a first gripping element (30; 30′), associated with the first lateral portion (24; 24′), which identifies a first flat gripping surface (32; 32′) adapted to be positioned in a final gripping position for locking the first external face (5a) of the panel (4). The first gripping element (30; 30′) comprises a first sliding surface (34; 234; 434, 434′) and the first lateral portion (24; 24′) comprises a second sliding surface (36; 236; 436, 436′ 476, 476′) placed in contact with the first sliding surface (34; 234; 434, 434′), wherein the first sliding surface (34; 234; 434, 434′) and the second sliding surface (36; 236; 436, 436′ 476, 476′) are inclined at a predetermined angle (A; A1) with respect to the first flat gripping surface (32; 32′) of the first element (30; 30′) so that, during the mutual sliding of the first gripping element (30; 30′) with respect to the first lateral portion (24; 24′), the first flat gripping surface (32; 32′) approaches the first external face (5a) of the panel (4) up to the final gripping position.

### TECHNICAL FIELD OF THE INVENTION

The present invention falls within the field of the construction of structures with panels, such as partitions, railings, balustrades with panels, shower enclosures, preferably made of glass, or doors with leaves preferably made of glass.

In particular, the present invention relates to the system for fastening such panels to a load-bearing support structure.

### DESCRIPTION OF THE STATE OF THE ART

The use of structures with panels for many applications is well known in the construction industry, such as partitions or railings or balustrades or shower enclosures, both in residential and public areas, or even doors with leaves comprising glass plates/leaves. In many cases, the panels preferably consist of glass plates to allow the structure to be transparent.

Such structures involve the connection of the panel at one or more of the lateral edges thereof to the load-bearing structure, consisting for example of a masonry column or a door frame.

In systems of the known type, the connection of the panel to the load-bearing structure involves the use of clamping devices in which two metal fastening elements are positioned in contact with the external faces of the panel along an edge thereof, and the two fastening elements are then locked and tightened together by means of fastening screws which affect the two fastening elements and close the elements themselves in a pack-like manner onto the panel.

However, such a solution belonging to the state of the art has some drawbacks.

A drawback of such a system consists of the complexity of the installation steps which require operators to correctly position and fasten the screws until the correct assembly is achieved.

Another drawback of the known type of system consists of the need to use tools to control the tightening torque value to ensure the durability of the fastening over time and/or to avoid the application of excessive forces which could lead to panel breakage, particularly when using panels made of glass plates.

A further drawback of the known type of system lies in the negative aesthetic contribution caused by the use of screws.

Therefore, the main object of the present invention is to solve, or at least partially overcome, the aforementioned drawbacks which characterize the state of the art. In particular, it is an object of the present invention to propose a solution which allows to simplify the panel installation operations with respect to the known type of systems.

It is another object of the present invention to propose a solution which improves the grip and stability of the panel in the correct position over time with respect to the known type of systems.

It is a further object of the present invention to propose a solution which minimises any breakage of the panel during the installation thereof.

It is another object of the present invention to propose a solution which improves the final aesthetic effect with respect to the known type of systems.

SUMMARY OF PRESENT INVENTION Therefore, in a first aspect thereof, the present invention relates to a fastening device for a panel, in particular for a glass plate, said device comprising:
a first element comprising a base portion, a first lateral portion extending from said base portion, a second lateral portion extending from said base portion and facing said first lateral portion, said lateral portions being adapted to define an intermediate zone for receiving said panel and wherein said first lateral portion is adapted to be arranged facing a first external face of said panel and wherein said second lateral portion is adapted to be arranged facing a second external face of said panel, wherein said fastening device comprises a first gripping element, associated with said first lateral portion, which identifies a first flat gripping surface adapted to be positioned in a final gripping position for locking said first external face of said panel, wherein said first gripping element comprises a first sliding surface and said first lateral portion comprises a second sliding surface placed in contact with said first sliding surface, wherein said first sliding surface and said second sliding surface are inclined at a predetermined angle with respect to said first flat gripping surface of said first gripping element so that, during the mutual sliding of said first gripping element with respect to said first lateral portion, said first flat gripping surface approaches said first external face of said panel up to said final gripping position.

This allows to advantageously simplify the panel installation operations with respect to the known type of systems.

In a preferred embodiment, said predetermined angle of inclination has a value comprised between 0.1° and 45°, preferably a value comprised between 1° and 20°, and even more preferably a value comprised between 1° and 5°.

Preferably, the second sliding surface is placed in contact with the first sliding surface.

According to a preferred alternative embodiment of the invention, the fastening device comprises a rolling assembly interposed between the first sliding surface and the second sliding surface.

This advantageously reduces the friction between the first sliding surface and the second sliding surface, facilitating the installation operations of the fastening device.

In a preferred embodiment, the fastening device comprises one or more intermediate elements adapted to be positioned between the first flat gripping surface of the first gripping element and the first external face of the panel and/or comprises one or more intermediate elements adapted to be positioned between the second lateral portion and the second external face of the panel.

This allows the correct positioning of the first flat gripping surface of the first gripping element against the first external face of the panel and/or the correct positioning of the second lateral portion with respect to the second external face of the panel.

Preferably, the fastening device comprises first displacement means for the first gripping element adapted to achieve the mutual displacement of the first gripping element with respect to the first lateral portion and the respective mutual displacement of the first sliding surface with respect to the second sliding surface.

According to a preferred embodiment of the invention, the first displacement means comprise screw means adapted to engage the first gripping element and to cooperate with the first gripping element to displace the first gripping element with respect to the first lateral portion.

In a preferred embodiment, the screw means displace the first element by means of a pushing action or the screw means displace the first element by means of a pulling action.

This allows an operator to act with a special tool to bring the first gripping element into the final locking position.

Preferably, the fastening device comprises a second gripping element, associated with the second lateral portion, which identifies a second flat gripping surface adapted to be positioned in a final gripping position for locking the second external face of the panel, wherein the second gripping element comprises a first sliding surface and the second lateral portion comprises a second sliding surface placed in contact with the first sliding surface of the second gripping element, wherein the first sliding surface and the second sliding surface are inclined at a predetermined angle with respect to the second flat gripping surface of the second gripping element so that, during the mutual sliding of the second gripping element with respect to the second lateral portion, the second flat gripping surface approaches the second external face of the panel up to the final gripping position.

According to a preferred embodiment of the invention, the first sliding surface and the second sliding surface are cylindrical or flat surfaces.

In a preferred embodiment, the fastening device comprises reference means adapted to detect the correct positioning of the first gripping element and the first flat gripping surface in the final gripping position.

This advantageously makes it possible to check the correct positioning of the first gripping element and the first flat gripping surface in the final gripping position and, if necessary, take action to use one or more intermediate adjustment elements.

Preferably, the fastening device is part of a hinge for rotatable connection of the panel to a load-bearing structure, wherein said hinge comprises a fastening member for fastening to the load-bearing structure and wherein the fastening member and the first element of the fastening device are articulated to rotate about an axis of rotation of the hinge.

This advantageously allows the use of the fastening device of the invention to make a door.

### BRIEF DESCRIPTION OF THE DRAWINGS

Further advantages, objects and features as well as embodiments of the present invention are defined in the claims and will be clarified hereinafter by means of the following description, in which reference is made to the accompanying drawing tables. In particular, in the figures:

FIG. 1 shows a door in the closed position obtained using hinges and fastening devices according to a first preferred embodiment of the invention;

FIG. 1A shows an enlarged detail of FIG. 1;

FIG. 2 shows a plan view from above of the door of FIG. 1;

FIG. 3 shows a plan view from above of the door of FIG. 1 in the open position;

FIG. 3A shows an enlarged detail of FIG. 3;

FIG. 4 shows the hinge of FIG. 3A in axonometric view;

FIG. 5 shows an exploded view of the hinge of FIG. 4;

FIG. 6 shows a detail of FIG. 5 isolated from the rest and partially sectioned;

FIG. 7 shows another detail of FIG. 5 isolated from the rest;

FIG. 7A shows a cross-sectional view of FIG. 7;

FIG. 8 shows a plan view of the section along the line VIII°-VIII° of the fastening device of FIG. 4 in a first operating position;

FIG. 8A shows an enlarged detail of FIG. 8;

FIG. 9 shows a plan view of the section along the line VIII°-VIII° of the fastening device of FIG. 4 in final operating position;

FIG. 9A shows an enlarged detail of FIG. 9;

FIG. 10 shows a fastening device according to an embodiment variant of the invention applied to a glass plate;

FIG. 11 shows an exploded view of FIG. 10;

FIG. 12 shows a side view of FIG. 10 with the fastening device in a first operating position;

FIG. 13 shows a side view of FIG. 10 with the fastening device in final operating position;

FIG. 14 shows a plan view of an element of the fastening device of the invention according to an embodiment variant;

FIGS. 15A, 15B and 15C show sectional views of the fastening device of the invention using the element of FIG. 14 in possible configurations during the installation thereof;

FIG. 16 shows a fastening device according to an embodiment variant of the invention applied to a glass plate;

FIG. 17 shows an exploded view of FIG. 16;

FIG. 18 shows a side view of FIG. 16 with the fastening device in a first operating position;

FIG. 19 shows a side view of FIG. 16 with the fastening device in final operating position;

FIG. 20 shows a fastening device according to an embodiment variant of the invention applied to a glass plate;

FIG. 21 shows an exploded view of FIG. 20;

FIG. 22 shows the fastening device of FIG. 21 during an installation step;

FIG. 23 shows a sectional view of FIG. 20;

FIG. 24 shows a fastening device according to an embodiment variant of the invention applied to a glass plate;

FIG. 25 shows an exploded view of FIG. 24;

FIG. 26 shows the fastening device of FIG. 25 during an installation step;

FIG. 27 shows a sectional view of FIG. 24;

FIG. 28 shows a fastening device according to an embodiment variant of the invention applied to a glass plate;

FIG. 29 shows an exploded view of FIG. 28;

FIG. 30 shows the fastening device of FIG. 29 during an installation step;

FIG. 31 shows a sectional view of FIG. 28;

FIG. 32 shows an axonometric view of an embodiment variant of a hinge according to the invention;

FIG. 33 shows an exploded view of the hinge of FIG. 32;

FIG. 34 shows an exploded view of the hinge of FIG. 32 during an installation step;

FIG. 35 shows a cross-sectional view of the hinge of FIG. 35 in the installed position.

### DETAILED DESCRIPTION OF SOME PREFERRED EMBODIMENTS OF THE PRESENT INVENTION

Although the present invention is described below with reference to embodiments thereof depicted in the drawing tables, the present invention is not limited to the embodiments described below and depicted in the drawing tables.

On the contrary, the embodiments described below and depicted in the drawing tables clarify certain aspects of the present invention, the object of which is in any case defined by the claims.

The present invention finds particular application in the construction field for making a door with glass leaf or a sliding glass door for a shower enclosure, as described for example in detail below.

However, it should be noted that the present invention is more generally advantageously applied in the construction of structures with various types of panels where the assembly of structural or furnishing panels is required, such as partitions or railings or balustrades with panels preferably in glass.

In addition to the glass solutions, the panels can also be of various types, such as sound-absorbing panels.

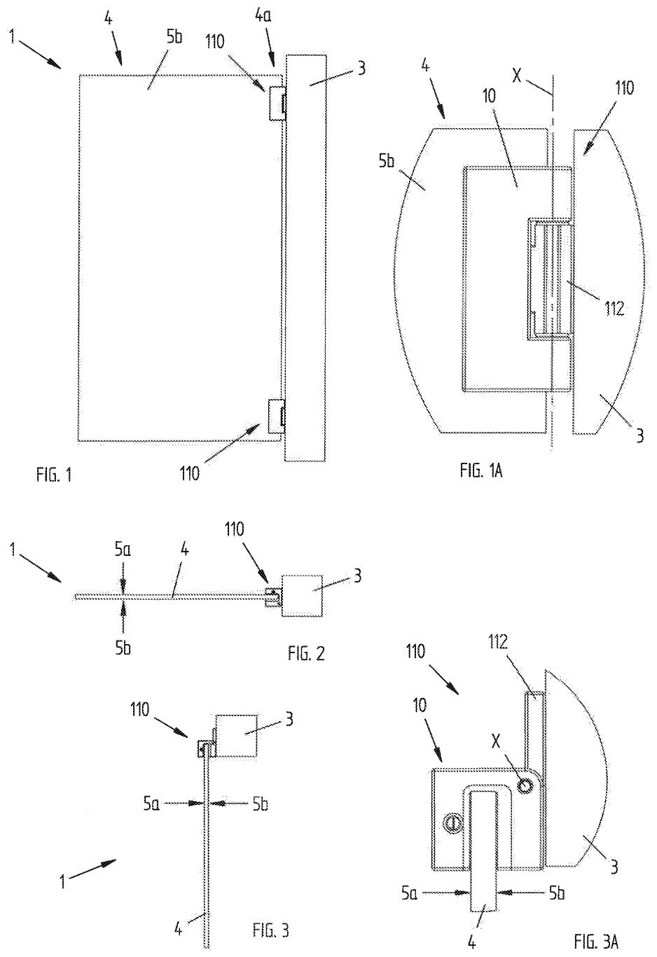

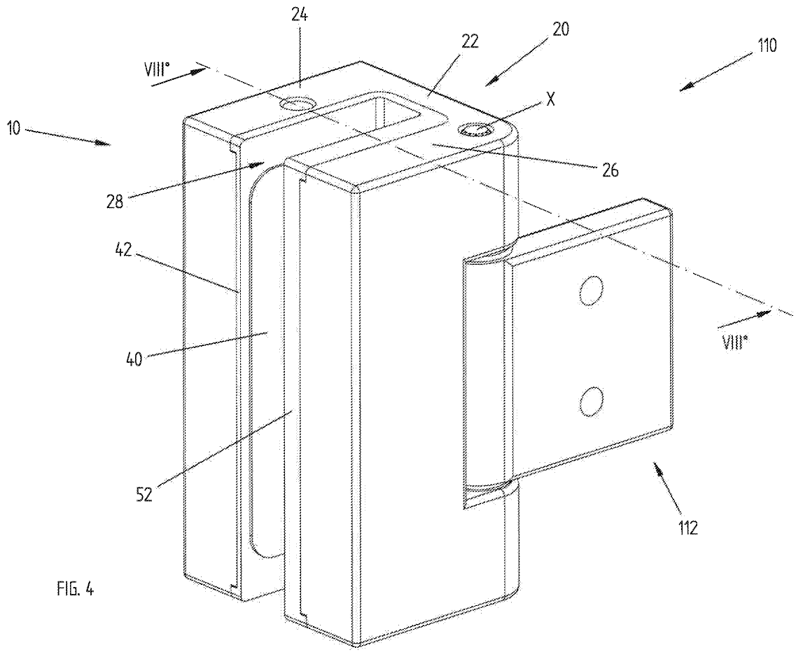

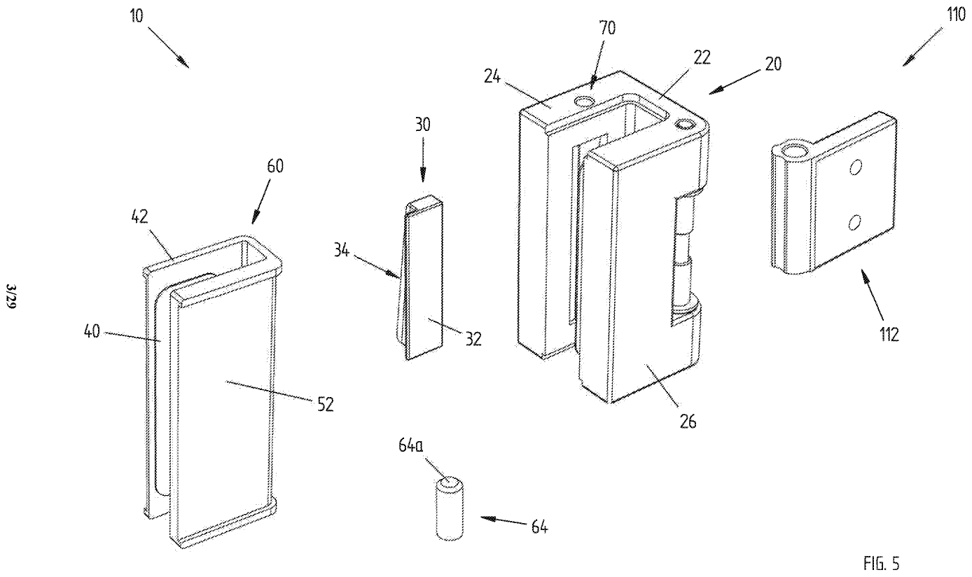

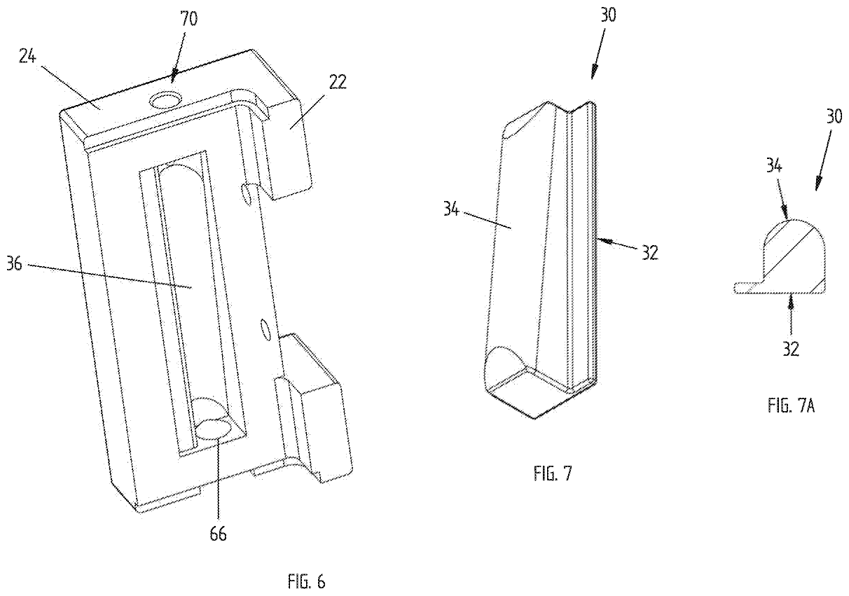

In the following with reference to FIGS. 1 to 9, a first embodiment of the fastening device 10 according to the present invention and a use thereof in the construction of a door 1 with a glass plate 4 will be described.

The fastening device 10 according to such an embodiment is preferably part of a hinge 110 allowing the connection of the panel 4 of the door 1 consisting of the glass plate 4 to the load-bearing structure 3 formed by the frame of the door 1 itself. In FIG. 1, the frame 3 of the door 1 is identified by a column 3 to which the panel 4 of the door 1 is rotatably fastened by means of two fastening devices 10 and respective hinges 110.

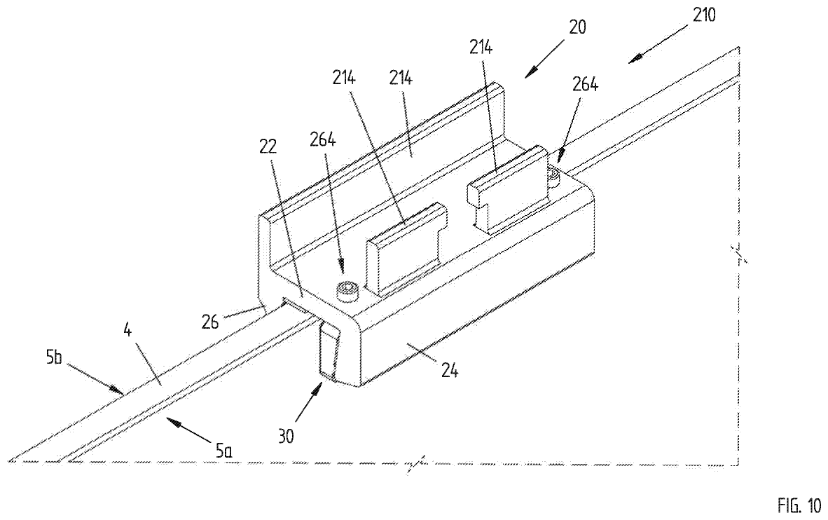

In preferred embodiment variants, the load-bearing structure can be any structure adapted to receive a panel, preferably a glass plate. For example, the load-bearing structure can consist of a part of a frame adapted to support a shower enclosure wall, as shown for example in FIGS. 10, 16, 20, 24 and 28.

The panel 4, in this case the glass plate 4, is generally characterised by a plate-like shape in which external faces 5a, 5b which are parallel, or substantially parallel, are identified. It should also be noted that the external faces of the panel may not be parallel for the entire extension thereof, e.g., they may bear raised aesthetic motifs or the like. In the context of the present invention, however, it is considered important that the parallel external faces 5a, 5b of the panel are parallel at least in the area at the fastening device 10.

In the embodiment illustrated, the panel consisting of the glass plate 4 is preferably rectangular in shape. In preferred embodiment variants, the panel can have different shapes.

In FIG. 1, the two fastening devices 10 and respective hinges 110 are associated with the right side edge 4a of the glass plate 4. In embodiment variants, however, the fastening devices used may differ in number with respect to the two shown in FIG. 1, depending on the size and/or weight of the panel to be fastened.

Furthermore, the various fastening devices used for the panel will be essentially the same as each other. For this purpose, reference will be made in the following description to one of such fastening devices, it being understood that what is described may be extended mutatis mutandis to the other fastening devices.

The fastening device 10 according to the invention comprises, firstly, a first element 20 in which a base portion 22 is identified, a first lateral portion 24 extending from the base portion 22 and a second lateral portion 26 extending from the base portion 22 and facing the first lateral portion 24.

The first element 20 is substantially configured to have a U-shape in which the lateral portions 24, 26 define an intermediate zone 28 for receiving the glass plate 4. The first lateral portion 24 is therefore adapted to be arranged facing the first external face 5a of the glass plate 4 and the second lateral portion 26 is adapted to be arranged facing the second external face 5b of the glass plate 4.

To allow the rotatable connection of the glass plate 4, the hinge 110 comprises a fastening member 112 for fastening to the column 3, wherein the fastening member 112 and the first element 20 of the fastening device 10 are articulated to rotate about an axis of rotation X of the hinge 110.

Suitable connection means, such as screws and/or dowels, are preferably used to connect the fastening member 112 to the column 3.

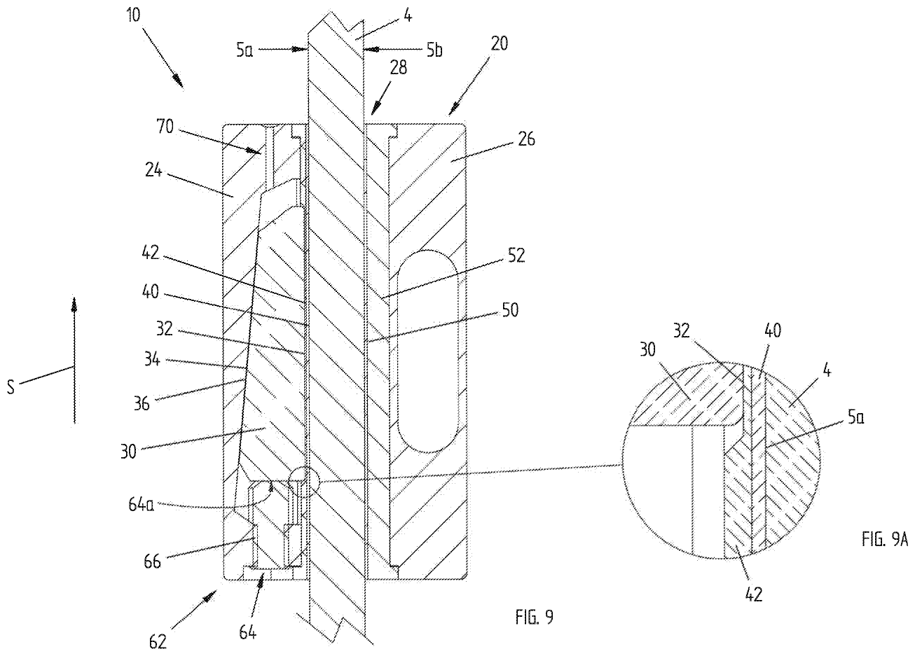

According to an aspect of the present invention, the fastening device 10 comprises a first gripping element 30, associated with the first lateral portion 24, which identifies a first flat gripping surface 32 adapted to be positioned in a final gripping position for locking the first external face 5a of the glass plate 4 (as shown in FIG. 9).

The first gripping element 30 comprises a first sliding surface 34 and the first lateral portion 24 of the first element 20 comprises a second sliding surface 36 placed in contact with the first sliding surface 34 of the first gripping element 30. The first sliding surface 34 and the second sliding surface 36 are inclined at a predetermined angle A with respect to the first flat gripping surface 32 of the first gripping element 30.

Preferably, said predetermined angle A is comprised between 0.1° and 45°, more preferably comprised between 1° and 20°, and even more preferably comprised between 1° and 5°. In the preferred embodiment illustrated, the predetermined angle A is equal to 5°.

The inclined sliding surfaces 34, 36 are preferably surfaces with a curved cross-section, e.g., with a circular cross-section (FIG. 7A). The sliding surfaces 34, 36 are therefore preferably defined by respective cylindrical surfaces.

In embodiment variants, however, the inclined sliding surfaces can assume different cross-sections, e.g., surfaces with mixtilinear or straight cross-section.

For example, the inclined sliding surfaces may be flat surfaces with straight cross-section.

The inclination of the sliding surfaces 34, 36 of the first gripping element 30 and of the first lateral portion 24, when the first gripping element 30 is slid along a preferred sliding direction S, causes the first flat gripping surface 32 of the first gripping element 30 to approach the first external face 5a of the glass plate 4 up to the final gripping position.

In such a position, moreover, the second lateral portion 26 of the first element 20 locks the second external face 5b of the glass plate 4.

In a preferred embodiment, not illustrated, in the final gripping position the first flat gripping surface is placed in direct contact with the first external face of the glass plate.

Similarly, in a preferred embodiment, not illustrated, the second lateral portion is placed in direct contact with the second external face of the glass plate.

In the embodiment illustrated in the figures, in the final gripping position, the first flat gripping surface 32 of the first gripping element 30 is not placed in direct contact with the first external face 5a of the glass plate 4 and preferably comprises one or more intermediate elements 40, 42 adapted to be positioned between the first flat gripping surface 32 of the first gripping element 30 and the first external face 5a of the glass plate 4, in this case two intermediate elements 40, 42.

Similarly, and more preferably, one or more intermediate elements 50, 52 are adapted to be positioned between the second lateral portion 26 of the fastening element 20 and the second external face 5b of the glass plate 4, in this case two intermediate elements 50, 52.

Preferably, the first 40 of the intermediate elements 40, 42 which is placed in direct contact with the first external face 5a of the glass plate 4 is made of a material with a high friction coefficient adapted to ensure an adequate grip on the first external face 5a of the glass plate 4. For example, such a material can consist of rubber or an abrasive paper or an abrasive belt.

Preferably, the second 42 of the intermediate elements 40, 42 which is not placed in direct contact with the first external face 5a of the glass plate 4 is an elastically yielding element, preferably an elastic plastic material, e.g., plastic or nylon or PE, and advantageously deforms during the assembly operations, as shown in the detail of FIG. 9A.

In embodiment variants, it could be made of metal.

Preferably, the first 50 of the intermediate elements 50, 52 which is placed in direct contact with the second external face 5b of the glass plate 4 is made of a material with a high friction coefficient adapted to ensure an adequate grip on the second external face 5b of the glass plate 4. For example, such a material can consist of rubber or an abrasive paper or an abrasive belt.

Preferably, the second 52 of the intermediate elements 50, 52 which is not placed in direct contact with the second external face 5b of the glass plate 4 is an elastically yielding element, preferably an elastic plastic material, e.g., plastic or nylon or PE, and advantageously deforms during the assembly operations, as shown in the detail of FIG. 9A.

In embodiment variants, it could be made of metal.

More preferably, the second intermediate elements 42, 52 are part of a single U-shaped element 60 which favours the positioning thereof during installation.

Preferably, the intermediate elements 40, 42, 50, 52 each have a plate-like shape with a thickness which keeps constant for the entire extension thereof.

In the final assembled configuration, therefore, the fastening device 10 keeps the glass plate 4 gripped.

Two pairs of intermediate elements 40, 42, 50, 52 are used in the embodiment illustrated and described.

In embodiment variants, the number of intermediate elements actually used may be different. The number of intermediate elements actually used will preferably be defined during the installation steps based on the need to recover any clearance between the lateral portions of the first element and the external faces of the glass plate and thus ensure the correct and sufficient gripping force for the glass plate. Furthermore, in a possible embodiment variant, no intermediate elements can be used.

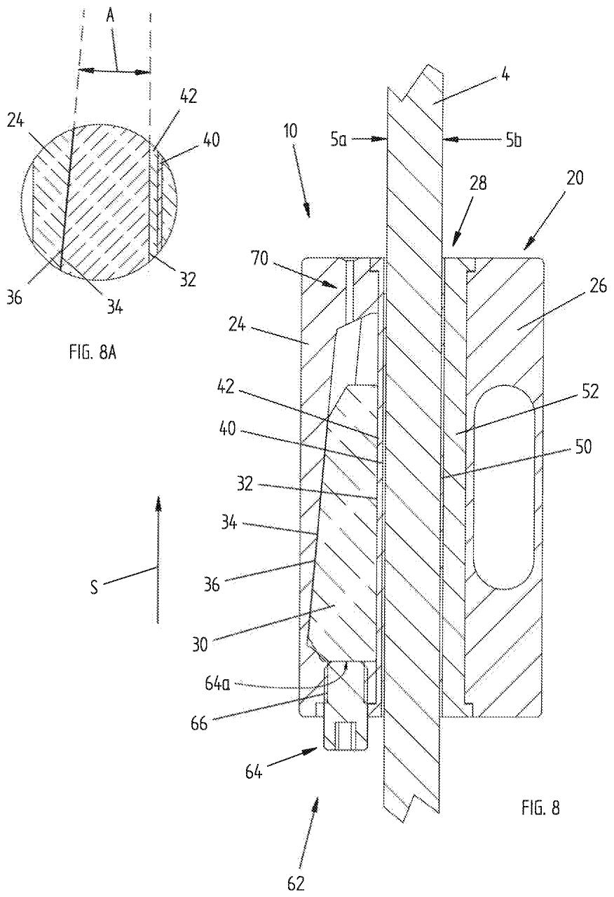

According to an aspect of the present invention, the fastening device 10 preferably comprises first displacement means 62 for the first gripping element 30 adapted to achieve the sliding of the first gripping element 30 with respect to the first lateral portion 24 along said sliding direction S, better visible in FIGS. 8 and 9.

According to a preferred embodiment, the first displacement means 62 comprise screw means 64 adapted to engage the first element 20, preferably at the first lateral portion 24, and to cooperate with the first gripping element 30 to displace the first gripping element with respect to the first lateral portion 24.

More preferably, the first displacement means 62 comprise a screw 64 adapted to engage a threaded hole 66 made in the first lateral portion 24 and the head 64a of the screw cooperates with the first gripping element 30 to push it along the sliding direction S during installation.

The operator can easily act with a special tool, such as a screwdriver, to bring the first gripping element 30 into the final locking position.

In the first lateral portion 24, a channel 70 is also preferably made which is adapted to receive a thread-like element, for example a screwdriver or pin punch or a dowel, which can be inserted from the outside to thrustingly act on the first gripping element 30 and favour the removal of the gripping element 30 in any disassembly operations.

From what has been described, it is clear that the installation of a glass plate, or a panel in general, is simplified with respect to the known type of systems requiring the use of screws.

The proposed solution also advantageously improves the grip and stability of the panel in the correct position over time with respect to the known type of systems.

Advantageously, the risk of breakage is minimised during panel installation.

Furthermore, advantageously, the final aesthetic effect with respect to the known type of systems is improved by the fact that there are no further mutual locking elements between the fastening elements, such as locking screws.

It is evident how such an embodiment allows to achieve the advantages mentioned above.

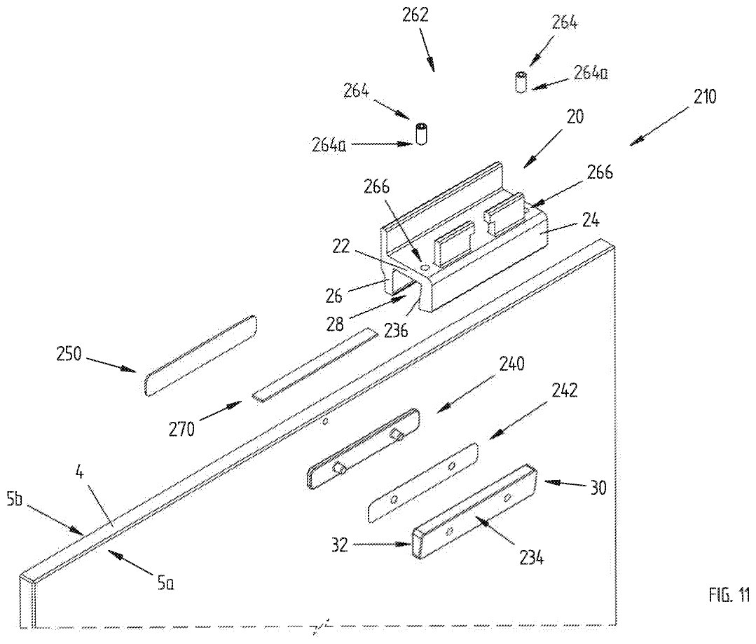

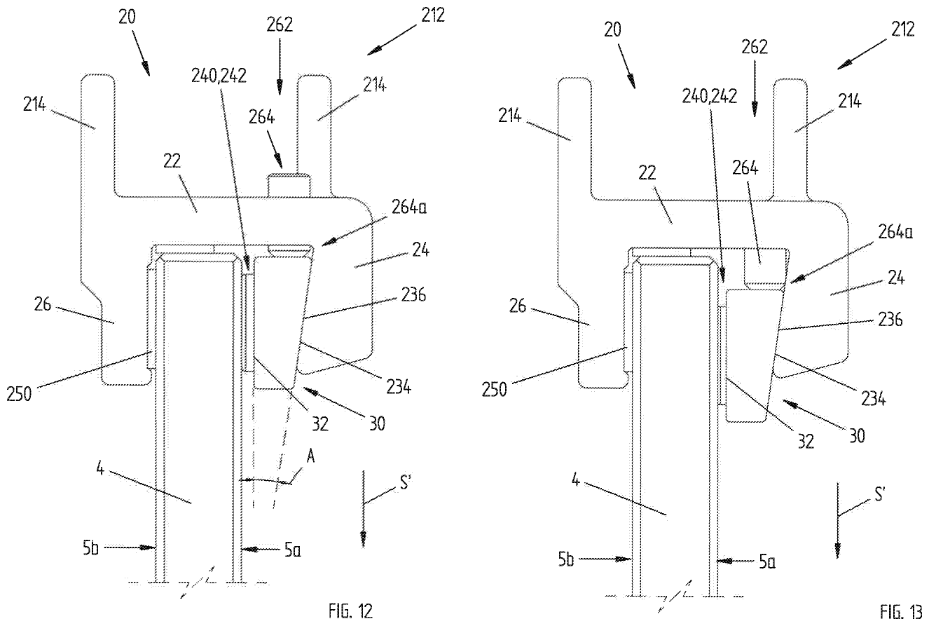

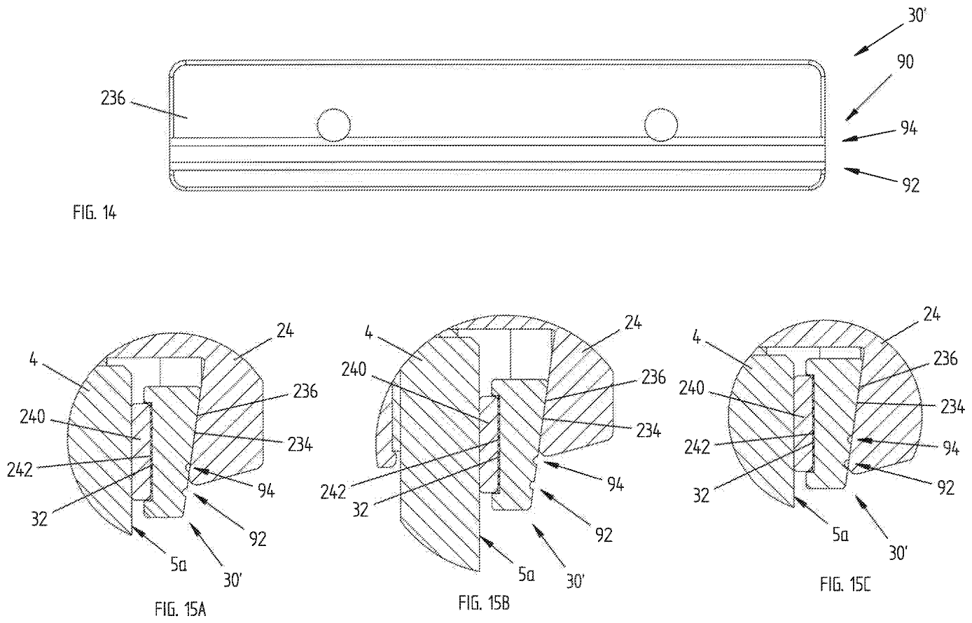

With reference to FIGS. 10 to 13, an embodiment variant of the fastening device 210 of the invention is shown.

The component parts which are equivalent to the preferred embodiment described with reference to FIGS. 1 to 9 are identified by the same reference numbers.

According to such an embodiment, the fastening device 210 is preferably used to mount a glass plate 4 to a load-bearing structure of a shower enclosure, not illustrated. The fastening device 210 according to such an embodiment can be used to assemble the glass plate 4 to the frame of the shower enclosure in a fixed manner, or to assembly the glass plate 4 to the frame of the shower enclosure frame in a sliding manner to make the door of the shower enclosure itself.

The fastening device 210 according to the invention comprises a first element 20 in which a base portion 22 is identified, a first lateral portion 24 extending from the base portion 22 and a second lateral portion 26 extending from the base portion 22 and facing the first lateral portion 24.

The first element 20 is substantially configured to have a U-shape in which the lateral portions 24, 26 define an intermediate zone 28 for receiving the glass plate 4. The first lateral portion 24 is therefore adapted to be arranged facing the first external face 5a of the glass plate 4 and the second lateral portion 26 is adapted to be arranged facing the second external face 5b of the glass plate 4.

Suitable connection means 212 are preferably used to connect the first element 20 to the load-bearing structure of the shower enclosure.

For example, the connection means 212 comprise fins 214 protruding from the base portion 22 of the first element 20 to define a channel for receiving an upper support bar of the shower enclosure (not shown).

The fastening device 210 comprises a first gripping element 30, associated with the first lateral portion 24, which identifies a first flat gripping surface 32 adapted to be positioned in a final gripping position for locking the first external face 5a of the glass plate 4 (as shown in FIG. 13).

The first gripping element 30 comprises a first sliding surface 234 and the first lateral portion 24 of the first element 20 comprises a second sliding surface 236 placed in contact with the first sliding surface 234 of the first gripping element 30.

The first sliding surface 234 and the second sliding surface 236 are inclined at a predetermined angle A with respect to the first flat gripping surface 32 of the first gripping element 30.

Preferably, said predetermined angle A is comprised between 0.1° and 45°, more preferably comprised between 1° and 20°, and even more preferably comprised between 1° and 5°. In the preferred embodiment illustrated, the predetermined angle A is equal to 8°.

The inclined sliding surfaces 234, 236 are preferably flat surfaces and therefore have a straight cross-section.

The inclination of the sliding surfaces 234, 236 of the first gripping element 30 and of the first lateral portion 24, when the first gripping element 30 is slid along a preferred sliding direction S′, causes the first flat gripping surface 32 of the first gripping element 30 to approach the first external face 5a of the glass plate 4 up to the final gripping position.

In such a position, moreover, the second lateral portion 26 of the first element 20 locks the second external face 5b of the glass plate 4.

Two intermediate elements 240, 242 are preferably positioned between the first flat gripping surface 32 of the first gripping element 30 and the first external face 5a of the glass plate 4: the first 240 of the intermediate elements is placed in direct contact with the first external face 5a of the glass plate 4 and is preferably made of a material with a low friction coefficient, e.g., made of PE or Nylon.

Preferably, the second 242 of the intermediate elements 240, 242 which is not placed in direct contact with the first external face 5a of the glass plate 4 acts as a spacer element of the first intermediate element 240. Only one intermediate spacer element 242 is shown in the figures by way of illustration.

In embodiment variants, the number of intermediate spacer elements actually used may be different, viz., two or more intermediate spacer elements. The number of intermediate spacer elements actually used will preferably be defined during installation. Furthermore, in a possible embodiment variant, no intermediate spacer elements can be used. Preferably, the intermediate spacer elements are made of a rigid material, such as a rigid plastic material or a metal.

One or more intermediate elements 250 are positioned between the second lateral portion 26 of the fastening device 20 and the second external face 5b of the glass plate 4, in this case only one intermediate element 250.

Preferably, the intermediate element 250 is made of a material with a high friction coefficient adapted to ensure an adequate grip on the second external face 5b of the glass plate 4. For example, such a material can consist of rubber or an abrasive paper or an abrasive belt.

Preferably, the intermediate elements 240, 242, 250 each have a plate-like shape with a thickness which keeps constant for the entire extension thereof.

In the final assembled configuration, therefore, the fastening device 210 keeps the glass plate 4 gripped.

The fastening device 210 preferably comprises first displacement means 262 for the first gripping element 30 adapted to make the first gripping element 30 slide with respect to the first lateral portion 24 along said sliding direction S′.

According to a preferred embodiment, the first displacement means 262 comprise screw means 264 adapted to engage the first element 20, preferably at the base portion 22, and to cooperate with the first gripping element 30 to displace the first gripping element with respect to the first lateral portion 24.

More preferably, the first displacement means 262 comprise a pair of screws 264 adapted to engage respective threaded holes 266 made in the base portion 22 and the screw heads 264a cooperate with the first gripping element 30 to push it along the sliding direction S′.

When driving the screws 264, the first gripping element 30 is pushed along the sliding direction S′ preferably away from the base portion 22.

The operator can easily act with a special tool, such as a screwdriver, to bring the first gripping element 30 into the final locking position.

Finally, a further protection element 270 is preferably interposed between the base portion 22 and the glass plate 4.

It is evident how such an embodiment allows to achieve the advantages mentioned above.

With reference to FIG. 14, an embodiment variant of the first gripping element 30′ is shown, which can preferably be used in the fastening device 210 described with reference to FIGS. 10 to 13.

Preferably, the first gripping element 30′ is provided with reference means 90 used during installation to define the correct number of spacer elements 242 for correct assembly and to obtain the adequate gripping force against the glass plate 4 once the final assembled position has been reached.

The reference means 90 comprise, preferably, two reference notches 92, 94 defined longitudinally on the first gripping element 30′. The display or non-display of such reference notches 92, 94 during the installation operations will give the operator useful indications on the correct number of spacer elements 242.

FIGS. 15A to 15C show the three possible conditions which can occur during installation, followed by the necessary adjustment operations, as described below.

If in the condition shown in FIG. 15A, viz., only the second notch 92 is visible to the operator, this means that the correct number of spacer adjustment element(s) 242 is currently used.

If in the condition shown in FIG. 15B, viz., the two notches 92, 94 are visible to the operator, this means that the spacer adjustment element(s) 242 currently used are excessive in number and do not define the correct assembly of the first gripping element 30′. One or more spacer adjustment element(s) 242 are therefore removed until the ideal condition of FIG. 15A is reached.

If in the condition shown in FIG. 15C, viz., neither of the two notches 92, 94 is visible to the operator, this means that the spacer adjustment element(s) 242 currently used are insufficient in number and do not define the correct assembly of the first gripping element 30′. One or more spacer adjustment element(s) 242 is/are therefore added until the ideal condition of FIG. 15A is reached.

In embodiment variants, instead of adding or removing spacer elements 242, the spacer element can be replaced with a spacer element of greater or lesser thickness as required.

It is evident how such an embodiment allows to achieve the advantages mentioned above.

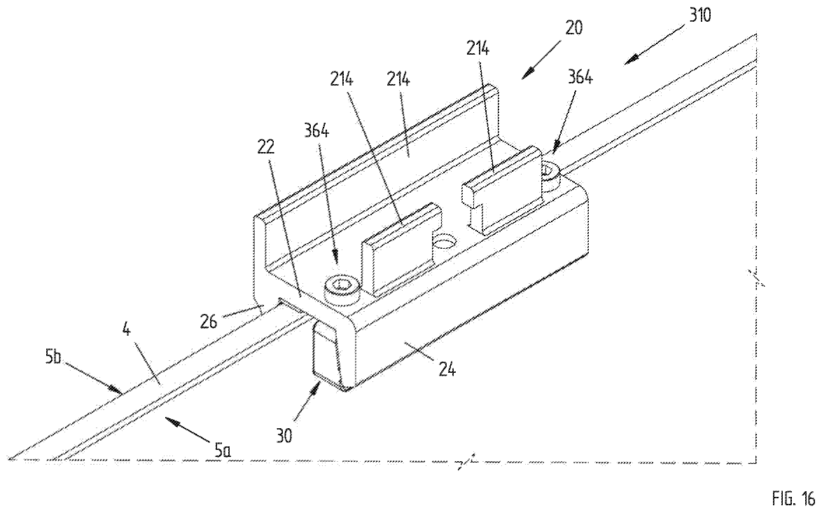

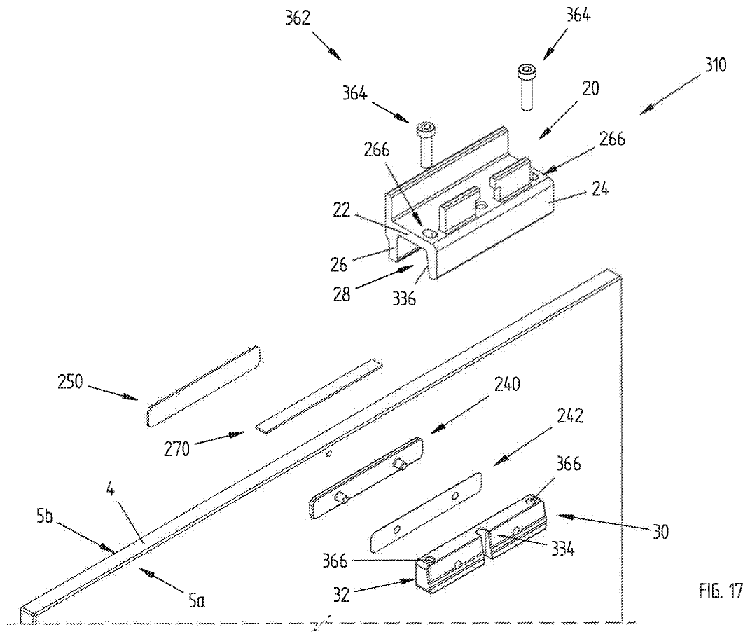

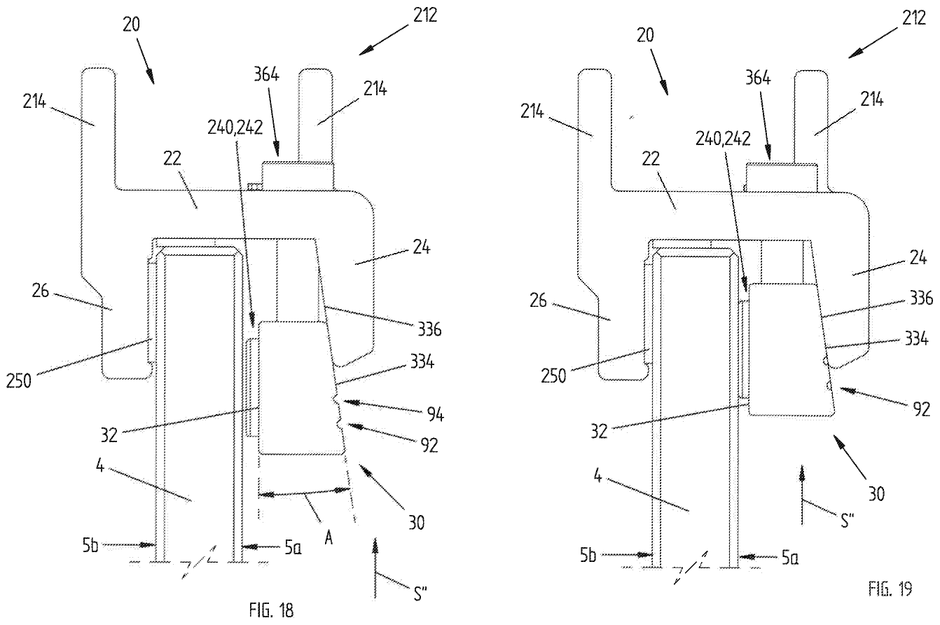

With reference to FIGS. 16 to 19, another embodiment variant of the fastening device 310 of the invention is shown.

The component parts which are equivalent to the preferred embodiment described with reference to FIGS. 10 to 13 are identified by the same reference numbers.

Such an embodiment differs from the preferred embodiment described with reference to FIGS. 10 to 13 due to the different mutual inclination between the inclined sliding surfaces 334, 336 of the first gripping element 30 and the first lateral portion 24.

Furthermore, the first displacement means 362 according to such an embodiment allow the displacement of the first gripping element 30 by means of a pulling action of the first gripping element 30 itself.

Preferably, the first displacement means 362 comprise screw means 364 adapted to engage the first element 20, preferably at the base portion 22, and to cooperate with the first gripping element 30 to displace the first gripping element with respect to the first lateral portion 24.

More preferably, the first displacement means 362 comprise a pair of screws 364 associated with the base portion 22 and adapted to engage in respective threaded holes 366 made in the first gripping element 30.

When driving the screws 366, the first gripping element 30 is pulled along the sliding direction S″ preferably approaching the base portion 22.

The operator can easily act with a special tool, such as a screwdriver, to bring the first gripping element 30 into the final locking position.

It is evident how such an embodiment allows to achieve the advantages mentioned above.

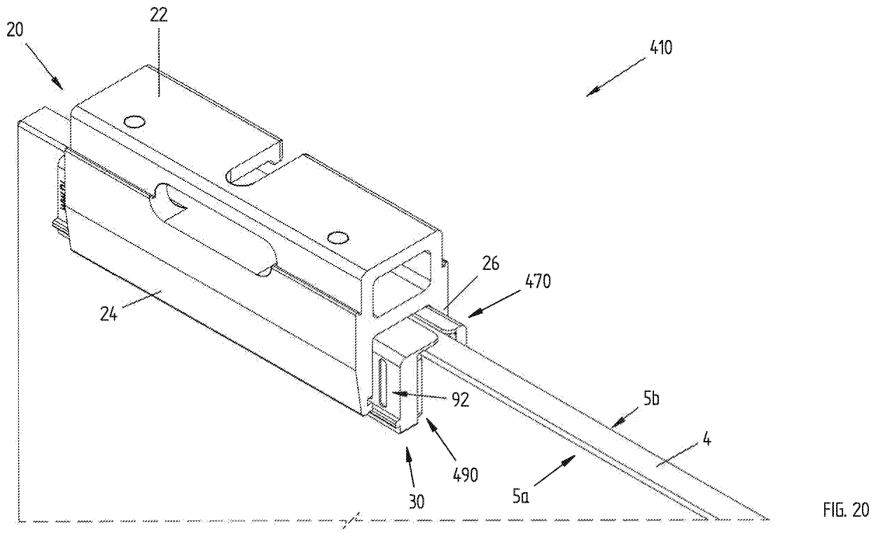

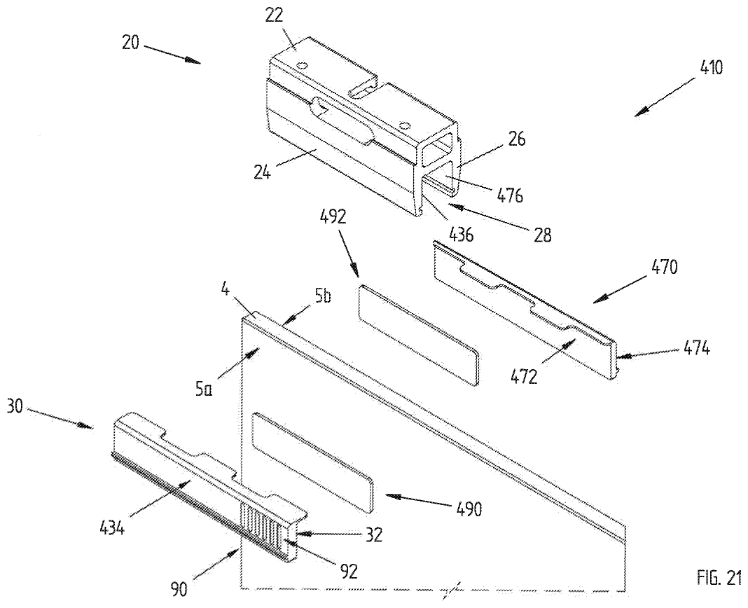

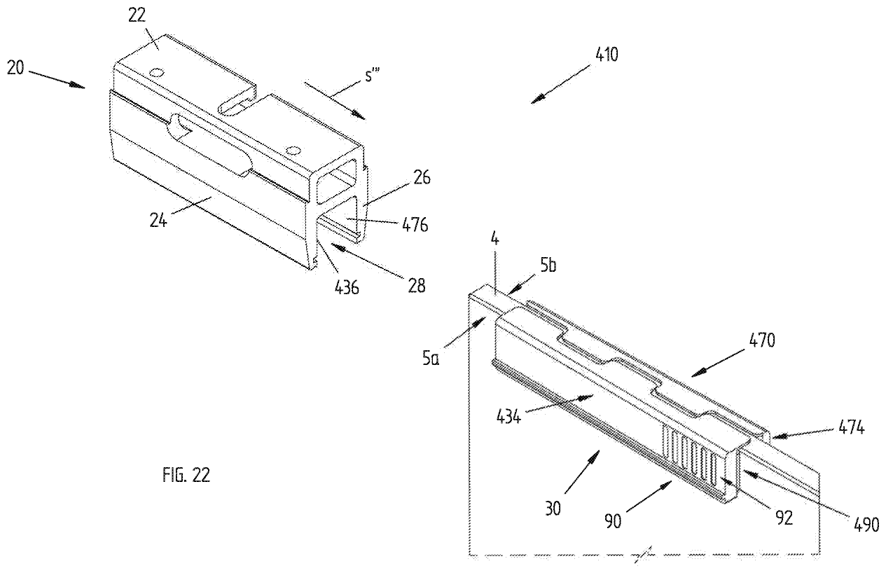

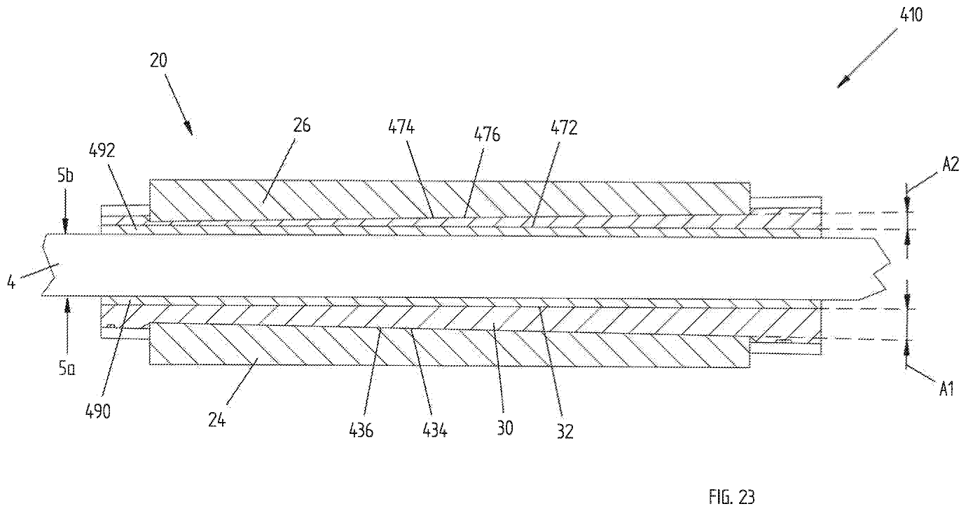

With reference to FIGS. 20 to 23, another embodiment variant of the fastening device 410 of the invention is shown.

The component parts which are equivalent to the preferred embodiments described above are identified by the same reference numbers.

The fastening device 410 comprises a first element 20 in which a base portion 22 is identified, a first lateral portion 24 extending from the base portion 22 and a second lateral portion 26 extending from the base portion 22 and facing the first lateral portion 24.

The first element 20 is substantially configured to have a U-shape in which the lateral portions 24, 26 define an intermediate zone 28 for receiving the glass plate 4. The first lateral portion 24 is therefore adapted to be arranged facing the first external face 5a of the glass plate 4 and the second lateral portion 26 is adapted to be arranged facing the second external face 5b of the glass plate 4.

The fastening device 410 comprises a first gripping element 30, associated with the first lateral portion 24, which identifies a first flat gripping surface 32 adapted to be positioned in a final gripping position for locking the first external face 5a of the glass plate 4 (as shown in FIGS. 20 and 23).

The first gripping element 30 comprises a first sliding surface 434 and the first lateral portion 24 of the first element 20 comprises a second sliding surface 436 placed in contact with the first sliding surface 434 of the first gripping element 30.

The first sliding surface 434 and the second sliding surface 436 are inclined at a predetermined angle A1 with respect to the first flat gripping surface 32 of the first gripping element 30.

Preferably, said predetermined angle A1 is comprised between 0.1° and 45°, more preferably comprised between 1° and 20°, and even more preferably comprised between 1° and 5°. In the preferred embodiment illustrated, the predetermined angle A1 is equal to 1°.

The inclined sliding surfaces 434, 436 are preferably flat surfaces and therefore have a straight cross-section.

The fastening device 410 further comprises a second gripping element 470, associated with the second lateral portion 26, which identifies a second flat gripping surface 472 adapted to be positioned in a final gripping position for locking the second external face 5b of the glass plate 4 (as shown in FIG. 23).

The second gripping element 470 comprises a first sliding surface 474 and the second lateral portion 26 of the first element 20 comprises a second sliding surface 476 placed in contact with the first sliding surface 474 of the second gripping element 470.

The first sliding surface 474 and the second sliding surface 476 are inclined at a predetermined angle A2 with respect to the second flat gripping surface 472 of the second gripping element 470.

Preferably, said predetermined angle A2 is comprised between 0.1° and 45°, more preferably comprised between 1° and 20°, and even more preferably comprised between 1° and 5°. In the preferred embodiment illustrated, the predetermined angle A2 is equal to 1°.

The inclined sliding surfaces 474, 476 are preferably flat surfaces and therefore have a straight cross-section.

The inclination of the sliding surfaces 434, 436 of the first gripping element 30 and of the first lateral portion 24, when the first element 20 is slid along a preferred sliding direction S″, causes the first flat gripping surface 32 of the first gripping element 30 to approach the first external face 5a of the glass plate 4 up to the final gripping position.

The inclination of the sliding surfaces 474, 476 of the second gripping element 470 and of the second lateral portion 26, when the first element 20 is slid along said preferred sliding direction S″, causes the second flat gripping surface 472 of the second gripping element 470 to approach the second external face 5b of the glass plate 4 up to the final gripping position.

An intermediate element 490 is preferably positioned between the first flat gripping surface 32 of the first gripping element 30 and the first external face 5a of the glass plate 4.

Preferably, the intermediate element 490 is made of a material with a high friction coefficient adapted to ensure an adequate grip on the first external face 5a of the glass plate 4. For example, such a material can consist of rubber or an abrasive paper or an abrasive belt.

An intermediate element 492 is preferably positioned between the second flat gripping surface 472 of the second gripping element 470 and the second external face 5b of the glass plate 4.

Preferably, the intermediate element 492 is made of a material with a high friction coefficient adapted to ensure an adequate grip on the second external face 5b of the glass plate 4. For example, such a material can consist of rubber or an abrasive paper or an abrasive belt.

It should be noted how according to such an embodiment, during the installation operations the gripping elements 30, 470 are kept stationary while it is the first element 20 which is slid along said preferred sliding direction S″.

Preferably, the first gripping element 30′ is provided with reference means 90 used during installation to define the correct number of intermediate elements 490, 492 for correct assembly and to obtain the adequate gripping force against the glass plate 4 once the final assembled position has been reached.

The reference means 90 comprise, preferably, reference notches 92 defined vertically on the first gripping element 30. The display of the desired number of reference notches 92 during the installation operations will give the operator useful indications on the correct number of intermediate elements 490, 492 to be used. For example, it can conventionally be decided that the correct number of intermediate elements 490, 492 should only allow one notch 92 to be seen, as shown in FIG. 20.

It is evident how such an embodiment allows to achieve the advantages mentioned above.

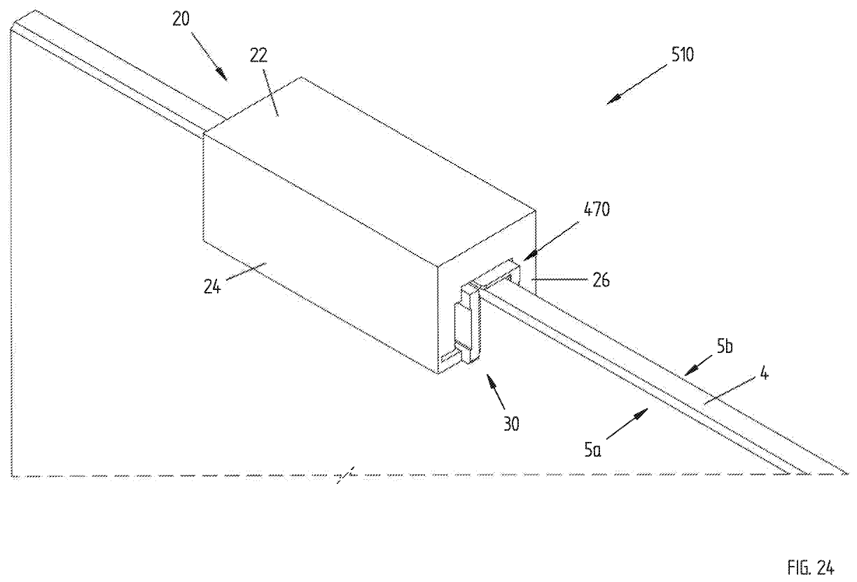

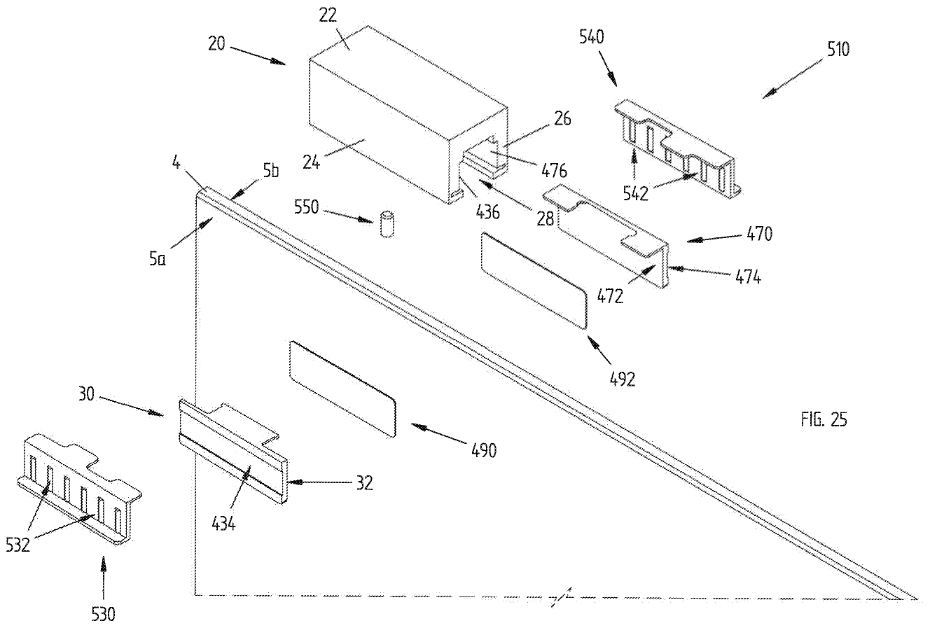

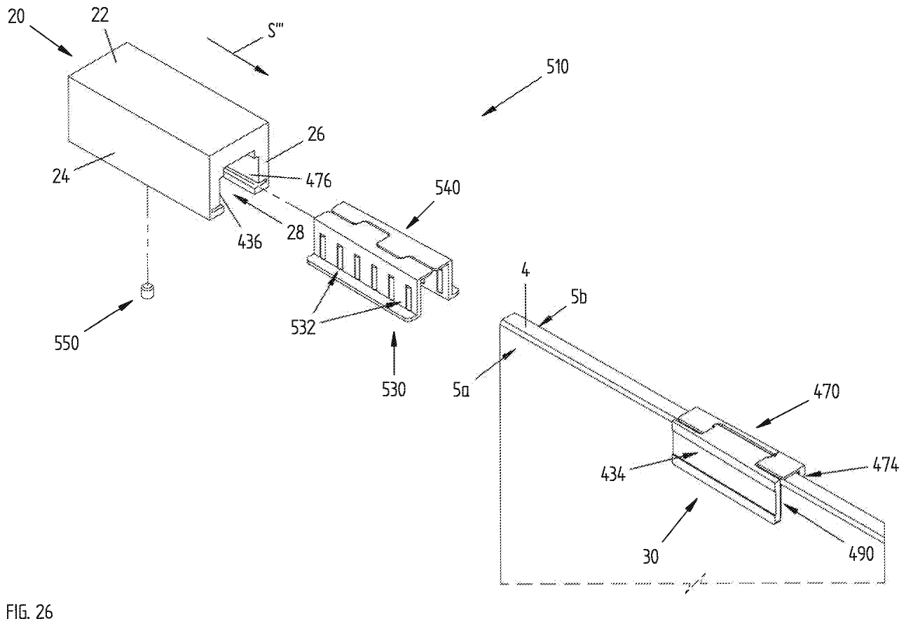

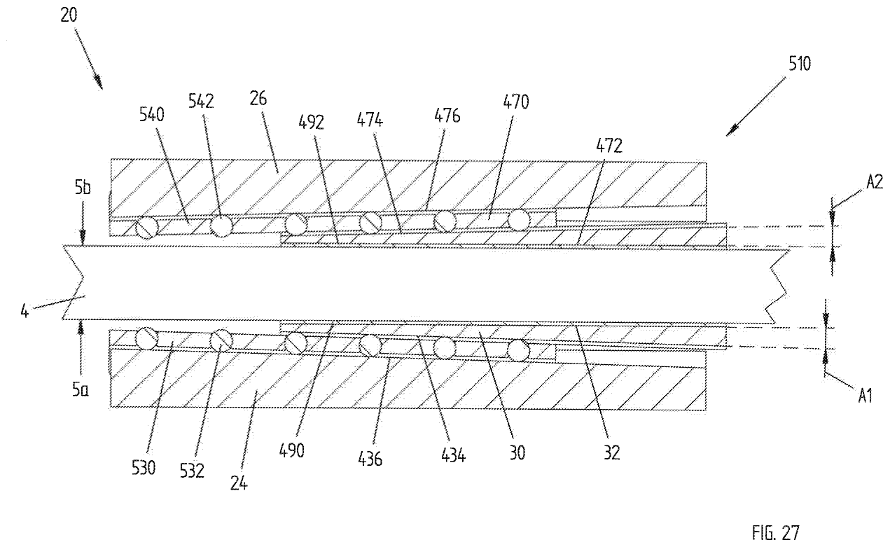

With reference to FIGS. 24 to 27, another embodiment variant of the fastening device 510 of the invention is shown.

The component parts which are equivalent to the preferred embodiment described with reference to FIGS. 20 to 23 are identified by the same reference numbers.

Such an embodiment differs from the preferred embodiment described with reference to FIGS. 20 to 23 in that it preferably comprises a first rolling assembly 530 interposed between the first sliding surface 434 of the first gripping element 30 and the second sliding surface 436 of the first lateral portion 24 and in that it preferably comprises a second rolling assembly 540 interposed between the first sliding surface 474 of the second gripping element 470 and the second sliding surface 476 of the second lateral portion 26.

The first rolling assembly 530 comprises, preferably, a plurality of rolling means 532 side by side, for example a plurality of equal rollers.

The second rolling assembly 540 preferably comprises a plurality of rolling means 542 side by side, for example a plurality of equal rollers.

The first rolling assembly 530 and the second rolling assembly 540 facilitate the installation operations of the fastening device 510 when the first element 20 is slid along said preferred sliding direction S″ and the gripping elements 30, 470 are held stationary. In fact, the first rolling assembly 530 significantly reduces the friction between the first sliding surface 434 of the first gripping element 30 and the second sliding surface 436 of the first lateral portion 24 and the second rolling assembly 540 significantly reduces the friction between the first sliding surface 474 of the second gripping element 470 and the second sliding surface 476 of the second lateral portion 26.

To ensure the locking of the first element 20 in the final assembled position, the fastening device 510 preferably comprises a locking system 550 which holds the elements of the device 510 itself in a fixed mutual position. The locking system 550 preferably comprises a screw/dowel which engages the first element 20, more preferably the first lateral portion 24, and interferes with the first rolling assembly 530 to keep the first element 20 and the first rolling assembly 530, and consequently all the elements of the device itself 510, in a mutually fixed position.

A rolling assembly as described above can be provided in any of the embodiments falling within the scope of the invention. Therefore, in general, a rolling assembly interposed between the first sliding surface of the first gripping element and the second sliding surface of the first lateral portion and/or a second rolling assembly interposed between the first sliding surface of the second gripping element and the second sliding surface of the second lateral portion can be provided.

It is evident how such an embodiment allows to achieve the advantages mentioned above.

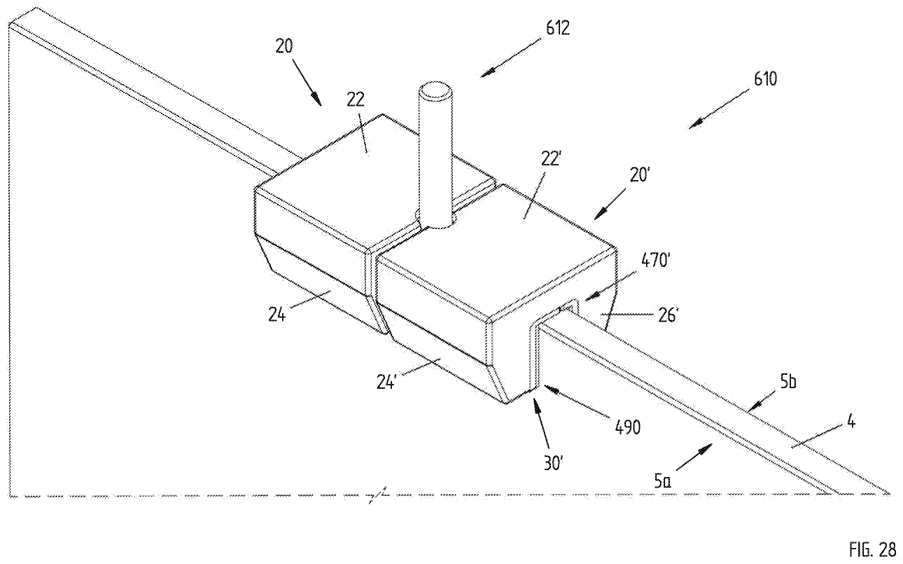

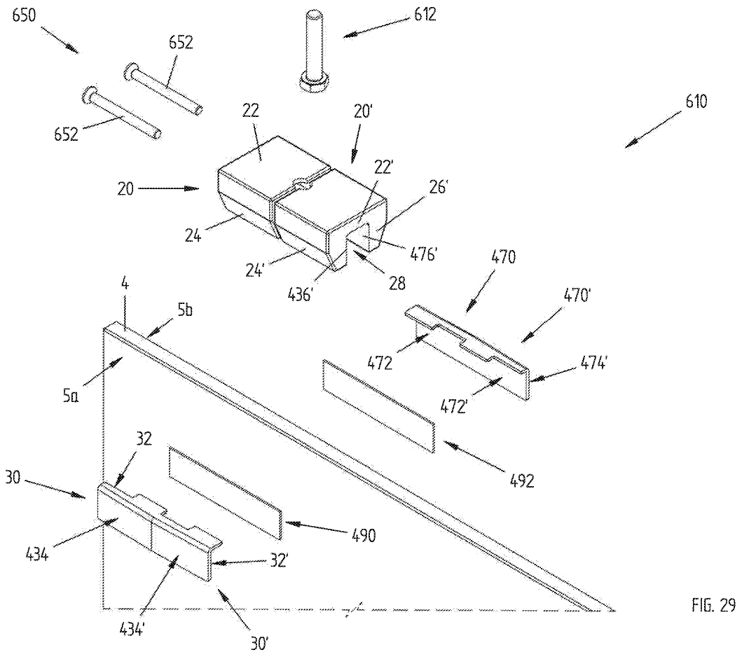

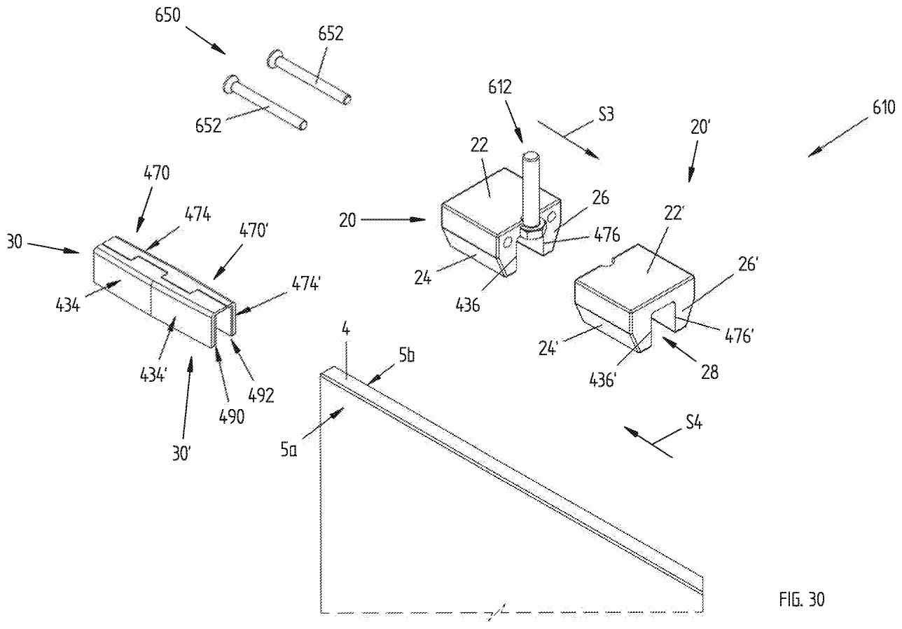

With reference to FIGS. 28 to 31, another embodiment variant of the fastening device 610 of the invention is shown.

The component parts which are equivalent to the preferred embodiments described above are identified by the same reference numbers.

The fastening device 610 according to such an embodiment substantially extends the solution shown and described with reference to FIGS. 20 to 23 in which there is a duplication of the elements illustrated.

The fastening device 610 comprises a pair of first elements 20, 20′ in which a base portion 22, 22′ is identified in each thereof, a first lateral portion 24, 24′ extending from the base portion 22, 22′ and a second lateral portion 26, 26′ extending from the base portion 22, 22′ and facing the first lateral portion 24, 24′.

The first elements 20, 20′ are substantially configured to have a U-shape in which the lateral portions 24, 26, 24′, 26′ define an intermediate zone 28 for receiving the glass plate 4. Therefore, the first lateral portion 24, 24′ is adapted to be arranged facing the first external face 5a of the glass plate 4 and the second lateral portion 26, 26′ is adapted to be arranged facing the second external face 5b of the glass plate 4.

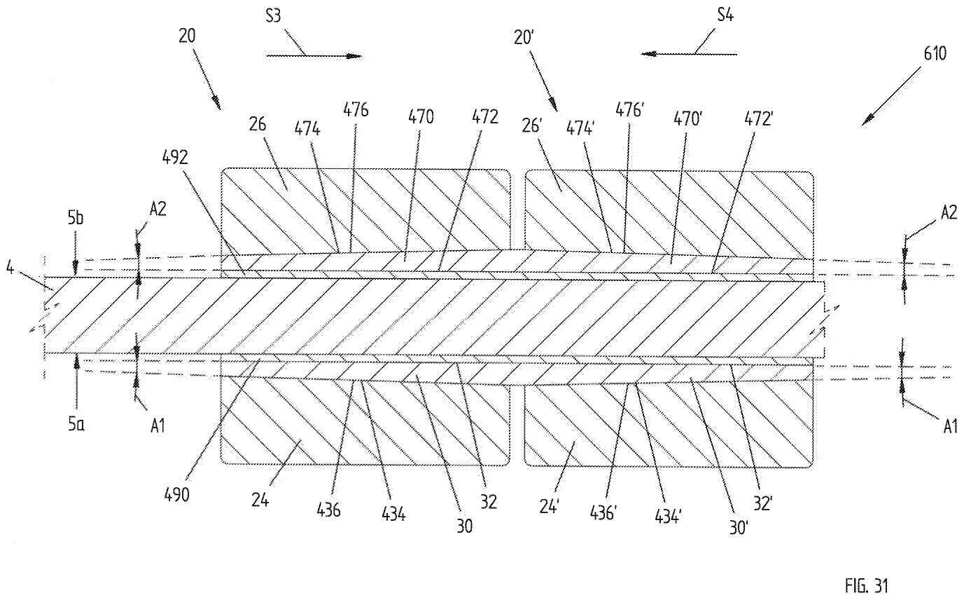

The fastening device 610 comprises a pair of first gripping elements 30, 30′, associated with respective first lateral portions 24, 24′, which identify a first flat gripping surface 32, 32′ adapted to be positioned in a final gripping position for locking the first external face 5a of the glass plate 4 (as shown in FIG. 31).

The first gripping elements 30, 30′ comprise a first sliding surface 434, 434′ and the first lateral portion 24, 24′ of the first element 20, 20′ comprises a second sliding surface 436, 436′ placed in contact with the first sliding surface 434, 434′ of the first gripping element 30, 30′.

The first sliding surface 434, 434′ and the second sliding surface 436, 436′ are inclined at a predetermined angle A1 with respect to the first flat gripping surface 32, 32′ of the first gripping element 30, 30′.

Preferably, said predetermined angle A1 is comprised between 0.1° and 45°, more preferably comprised between 1° and 20°, and even more preferably comprised between 1° and 5°. In the preferred embodiment illustrated, the predetermined angle A1 is equal to 1.5°.

The inclined sliding surfaces 434, 436, 434′, 436′ are preferably flat surfaces and therefore have a straight cross-section.

The fastening device 610 further comprises a pair of second gripping elements 470, 470′, each associated with the respective second lateral portion 26, 26′, which identify a second flat gripping surface 472, 472′ adapted to be positioned in a final gripping position for locking the second external face 5b of the glass plate 4 (as shown in FIG. 31).

The second gripping element 470, 470′ comprises a first sliding surface 474, 474′ and the second lateral portion 26, 26′ of the first element 20, 20′ comprises a second sliding surface 476, 476′ placed in contact with the first sliding surface 474, 474′ of the second gripping element 470, 470′.

The first sliding surface 474, 474′ and the second sliding surface 476, 476′ are inclined at a predetermined angle A2 with respect to the second flat gripping surface 472, 472′ of the second gripping element 470, 470′.

Preferably, said predetermined angle A2 is comprised between 0.1° and 45°, more preferably comprised between 1° and 20°, and even more preferably comprised between 1° and 5°. In the preferred embodiment illustrated, the predetermined angle A2 is equal to 1.5°.

The inclined sliding surfaces 474, 476, 474′, 476′ are preferably flat surfaces and therefore have a straight cross-section.

In an embodiment variant, the first sliding surfaces 474, 474′ of the second gripping element 470, 470′ and the respective sliding surfaces 476, 476′ of the second lateral portion 26, 26′ could not be inclined, viz. parallel, with respect to the second flat gripping surface 472, 472′ of the second gripping element 470, 470′.

The inclination of the sliding surfaces 434, 436, 434′, 436′ of the first gripping element 30, 30′ and of the first lateral portion 24, 24′, when the first elements 20, 20′ are slid along respective opposite sliding directions S3, S4, causes the first flat gripping surface 32, 32′ of the first gripping element 30, 30′ to approach the first external face 5a of the glass plate 4 up to the final gripping position.

The inclination of the sliding surfaces 474, 476, 474′, 476′ of the second gripping element 470, 470′ and of the second lateral portion 26, 26′, when the first elements 20, 20′ are slid along respective opposite sliding directions S3, S4, causes the second flat gripping surface 472, 472′ of the second gripping element 470, 470′ to approach the second external face 5b of the glass plate 4 up to the final gripping position.

The sliding of the first elements 20, 20′ along said opposite sliding directions S3, S4 is preferably achieved by means of a mutual approach system 650 of the first elements 20, 20′. Preferably, the approach system 650 comprises a screw system in which a pair of screws 652 is inserted through the first 20 of said elements 20, 20′ and screwed to the second 20′ of said elements 20, 20′.

The driving of the screws 652 causes the two first elements 20, 20′ to mutually approach along the respective directions S3, S4.

An intermediate element 490 is preferably positioned between the first flat gripping surfaces 32, 32′ of the first gripping elements 30, 30′ and the first external face 5a of the glass plate 4.

Preferably, the intermediate element 490 is made of a material with a high friction coefficient adapted to ensure an adequate grip on the first external face 5a of the glass plate 4. For example, such a material can consist of rubber or an abrasive paper or an abrasive belt.

An intermediate element 492 is preferably positioned between the second flat gripping surfaces 472, 472′ of the second gripping elements 470, 470′ and the second external face 5b of the glass plate 4.

Preferably, the intermediate element 492 is made of a material with a high friction coefficient adapted to ensure an adequate grip on the second external face 5b of the glass plate 4. For example, such a material can consist of rubber or an abrasive paper or an abrasive belt.

Suitable connection means 612 are preferably used to connect the fastening device 610 to a load-bearing structure of the shower enclosure.

In an embodiment variant, not illustrated, the first gripping element 30, 30′ is preferably provided with reference means, e.g., vertical notches, which can be used during installation to define the correct positioning of the intermediate elements 490, 492 and the correct assembly with the adequate gripping force against the glass plate 4 obtained once the final assembled position has been reached.

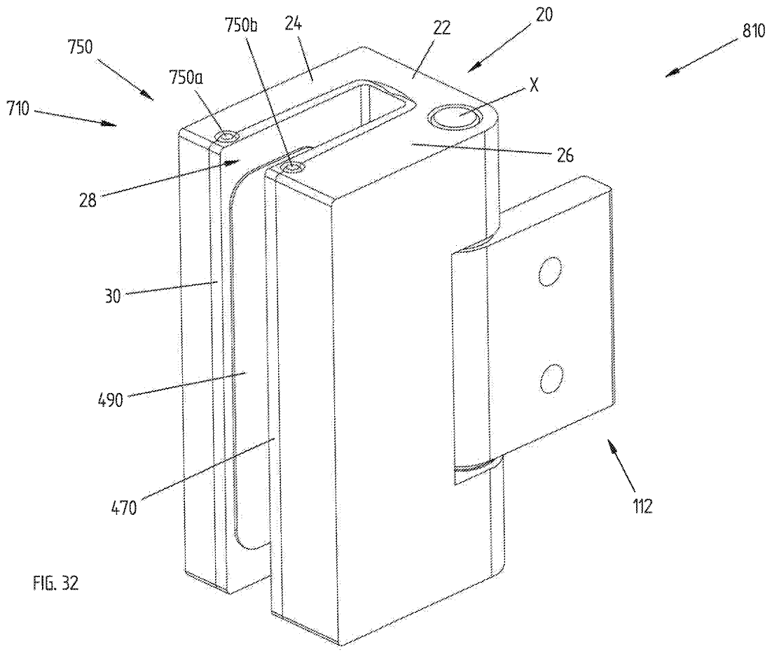

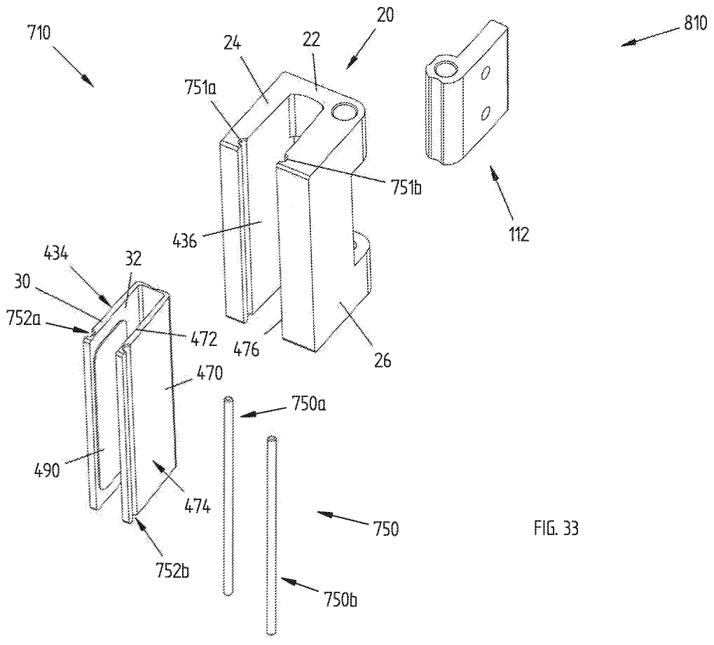

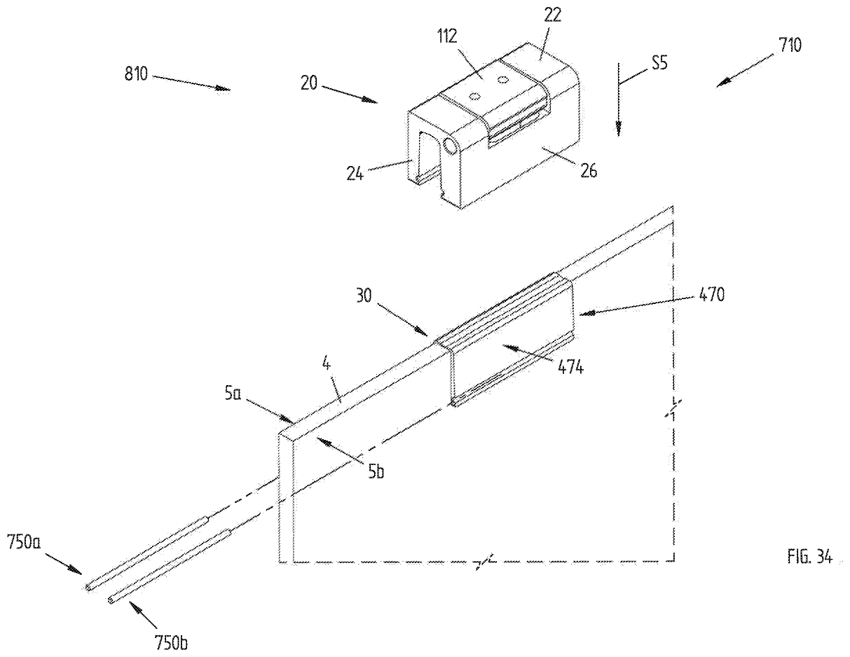

With reference to FIGS. 32 to 35, another embodiment variant of the fastening device 710 of the invention is shown. The fastening device 710 according to such an embodiment is preferably part of a hinge 810 which can be used to make a door, similarly to what has been described above with reference to FIGS. 1 to 9.

The component parts which are equivalent to the preferred embodiments described above are identified by the same reference numbers.

The fastening device 710 comprises a first element 20 in which a base portion 22 is identified, a first lateral portion 24 extending from the base portion 22 and a second lateral portion 26 extending from the base portion 22 and facing the first lateral portion 24.

The first element 20 is substantially configured to have a U-shape in which the lateral portions 24, 26 define an intermediate zone 28 for receiving the glass plate 4. The first lateral portion 24 is therefore adapted to be arranged facing the first external face 5a of the glass plate 4 and the second lateral portion 26 is adapted to be arranged facing the second external face 5b of the glass plate 4.

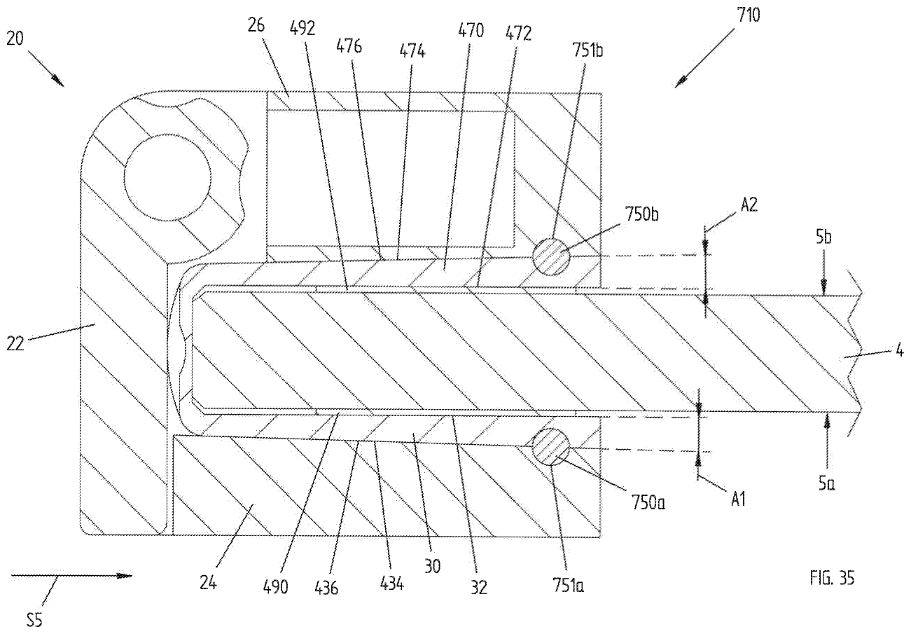

The fastening device 710 comprises a first gripping element 30, associated with the first lateral portion 24, which identifies a first flat gripping surface 32 adapted to be positioned in a final gripping position for locking the first external face 5a of the glass plate 4 (as shown in FIG. 35).

The first gripping element 30 comprises a first sliding surface 434 and the first lateral portion 24 of the first element 20 comprises a second sliding surface 436 placed in contact with the first sliding surface 434 of the first gripping element 30.

The first sliding surface 434 and the second sliding surface 436 are inclined at a predetermined angle A1 with respect to the first flat gripping surface 32 of the first gripping element 30.

Preferably, said predetermined angle A1 is comprised between 0.1° and 45°, more preferably comprised between 1° and 20°, and even more preferably comprised between 1° and 5°. In the preferred embodiment illustrated, the predetermined angle A1 is equal to 1.5°.

The inclined sliding surfaces 434, 436 are preferably flat surfaces and therefore have a straight cross-section.

The fastening device 710 further comprises a second gripping element 470, associated with the second lateral portion 26, which identifies a second flat gripping surface 472 adapted to be positioned in a final gripping position for locking the second external face 5b of the glass plate 4 (as shown in FIG. 35).

Preferably, the first gripping element 30 and the second gripping element 470 are part of a single U-shaped element which favours the positioning thereof during installation.

The second gripping element 470 comprises a first sliding surface 474 and the second lateral portion 26 of the first element 20 comprises a second sliding surface 476 placed in contact with the first sliding surface 474 of the second gripping element 470.

The first sliding surface 474 and the second sliding surface 476 are inclined at a predetermined angle A2 with respect to the second flat gripping surface 472 of the second gripping element 470.

Preferably, said predetermined angle A2 is comprised between 0.1° and 45°, more preferably comprised between 1° and 20°, and even more preferably comprised between 1° and 5°. In the preferred embodiment illustrated, the predetermined angle A2 is equal to 1.5°.

The inclined sliding surfaces 474, 476 are preferably flat surfaces and therefore have a straight cross-section.

The inclination of the sliding surfaces 434, 436 of the first gripping element 30 and of the first lateral portion 24, when the first element 20 is slid along a preferred sliding direction S5, causes the first flat gripping surface 32 of the first gripping element 30 to approach the first external face 5a of the glass plate 4 up to the final gripping position.

The inclination of the sliding surfaces 474, 476 of the second gripping element 470 and of the second lateral portion 26, when the first element 20 is slid along said preferred sliding direction S5, causes the second flat gripping surface 472 of the second gripping element 470 to approach the second external face 5b of the glass plate 4 up to the final gripping position.

An intermediate element 490 is preferably positioned between the first flat gripping surface 32 of the first gripping element 30 and the first external face 5a of the glass plate 4.

Preferably, the intermediate element 490 is made of a material with a high friction coefficient adapted to ensure an adequate grip on the first external face 5a of the glass plate 4. For example, such a material can consist of rubber or an abrasive paper or an abrasive belt.

If made of rubber, the intermediate element 490 undergoes a crushing during the installation of the fastening device 710.

An intermediate element 492 is preferably positioned between the second flat gripping surface 472 of the second gripping element 470 and the second external face 5b of the glass plate 4.

Preferably, the intermediate element 492 is made of a material with a high friction coefficient adapted to ensure an adequate grip on the second external face 5b of the glass plate 4. For example, such a material can consist of rubber or an abrasive paper or an abrasive belt.

If made of rubber, the intermediate element 492 undergoes a crushing during the installation of the fastening device 710.

It should be noted how according to such an embodiment, during the installation operations the gripping elements 30, 470 are kept stationary while the first element 20 is slid along said preferred sliding direction S5.

To ensure the locking of the first element 20 in the final assembled position, the fastening device 710 preferably comprises a locking system which keeps the elements of the device 710 itself in a fixed mutual position.

The locking system 750 preferably comprises a first cylindrical pin 750a which is inserted into a corresponding cylindrical hold defined, in the final assembled position, by two semi-cylindrical seats 751a, 752a made in the first lateral portion 24 and in the first gripping element 30, respectively.

The locking system 750 preferably comprises a second cylindrical pin 750b which is inserted into a corresponding cylindrical hole defined, in the final assembled position, by two semi-cylindrical seats 751b, 752b made in the second lateral portion 26 and in the second gripping element 470, respectively.

In a preferred embodiment, not illustrated, the first gripping element and/or the second gripping element is provided with reference means, e.g., reference notches, used during installation to define the correct number of intermediate elements for the correct assembly and achievement of the adequate gripping force against the glass plate once the final assembled position has been reached, analogous to what is described above.

It is evident how such an embodiment allows to achieve the advantages mentioned above.

It should be noted that in the above description, where reference is made to numerical angle values, due account must be taken of any variations due, for example, to construction tolerances arising from the materials and/or manufacturing processes of the elements concerned.

From what has been described, it can therefore be inferred that the fastening device of the invention allows to achieve the set objects and in particular allows to simplify the installation operations of a panel with respect to the known type of systems.

While the present invention has been described with reference to the particular embodiments depicted in the figures, it should be noted that the present invention is not limited to the particular embodiments depicted and described; on the contrary, further variations of the described embodiments fall within the scope of the present invention, which scope is defined by the claims.

1)-12) (canceled)

13. A fastening device for a panel, said fastening device comprising:
a first element comprising a base portion, a first lateral portion extending from said base portion, a second lateral portion extending from said base portion and facing said first lateral portion, said lateral portions being adapted to define an intermediate zone for receiving said panel, said first lateral portion being adapted to be arranged facing a first external face of said panel and said second lateral portion being adapted to be arranged facing a second external face of said panel; and
a first gripping element, associated with said first lateral portion, which identifies a first flat gripping surface adapted to be positioned in a final gripping position for locking said first external face of said panel,
wherein said first gripping element comprises a first sliding surface,
wherein said first lateral portion comprises a second sliding surface placed in contact with said first sliding surface, and
wherein said first sliding surface and said second sliding surface are inclined at a predetermined angle with respect to said first flat gripping surface of said first gripping element so that, during the mutual sliding of said first gripping element with respect to said first lateral portion, said first flat gripping surface approaches said first external face of said panel up to said final gripping position.

14. The fastening device according to claim 13, wherein said predetermined angle of inclination has a value comprised between 0.1° and 45°.

15. The fastening device according to claim 14, wherein said predetermined angle of inclination has a value comprised between 1° and 20°.

16. The fastening device according to claim 15, wherein said predetermined angle of inclination has a value comprised between 1° and 5°.

17. The fastening device according to claim 13, wherein said second sliding surface is placed into contact with said first sliding surface.

18. The fastening device according to claim 13, further comprising a rolling assembly interposed between said first sliding surface and said second sliding surface.

19. The fastening device according to claim 13, further comprising one or more intermediate elements adapted to be positioned between said first flat gripping surface of said first gripping element and said first external face of said panel and/or by comprising one or more intermediate elements adapted to be positioned between said second lateral portion and said second external face of said panel.

20. The fastening device according to claim 13, further comprising first displacement means for said first gripping element adapted to achieve the mutual displacement of said first gripping element with respect to said first lateral portion and the respective mutual displacement of said first sliding surface with respect to said second sliding surface.

21. The fastening device according to claim 20, wherein said first displacement means comprise screw means adapted to engage said first element and to cooperate with said first gripping element to displace said first gripping element with respect to said first lateral portion.

22. The fastening device according to claim 21, wherein said screw means displace said first element by means of a pushing action or said screw means displace said first element by means of a pulling action.

23. Device according to claim 13, further comprising a second gripping element, associated with said second lateral portion, which identifies a second flat gripping surface adapted to be positioned in a final gripping position for locking said second external face of said panel,
wherein said second gripping element comprises a first sliding surface and said second lateral portion comprises a second sliding surface placed in contact with said first sliding surface of said second gripping element, and
wherein said first sliding surface and said second sliding surface are inclined at a predetermined angle with respect to said second flat gripping surface of said second gripping element so that, during the mutual sliding of said second gripping element with respect to said second lateral portion, said second flat gripping surface approaches said second external face of said panel up to said final gripping position.

24. The fastening device according to claim 13, wherein said first sliding surface and said second sliding surface are cylindrical or flat surfaces.

25. The fastening device according to claim 13, further comprising reference means adapted to detect the correct positioning of said first gripping element and of said first flat gripping surface in said final gripping position.

26. The fastening device according to claim 13, wherein the fastening device is part of a hinge for the rotatable connection of said panel to a load-bearing structure,
wherein said hinge comprises a fastening member for fastening to said load-bearing structure, and
wherein said fastening member and said first element of said fastening device are articulated to rotate about an axis of rotation of said hinge.
